(19) United States
(12) Patent Application Publication
(10) Pub. No.: US 2017/0109525 A1
(43) Pub. Date: Apr. 20, 2017

(54) PROTECTING AN ITEM OF SOFTWARE

(71) Applicant: Irdeto B.V., Hoofddorp (NL)

(72) Inventor: Bahman Sistany, Ottawa (CA)

(21) Appl. No.: 15/300,576

(22) PCT Filed: Mar. 31, 2014
(86) PCT No.: PCT/EP2014/056422

§ 371 Date: Sep. 29, 2016

(51) Int. Cl. G06F 21/54; G06F 21/62

(52) U.S. Cl. CPC G06F 21/54; G06F 21/629; G06F 2221/033

(57) ABSTRACT

There is described a method of protecting an item of software. The method comprises (a) identifying an invariant which holds true at a specified point in the item of software; and (b) generating a protected item of software by inserting code at the specified point in the item of software. The code, when executed by a processor, is arranged to check whether the invariant holds true and, in response to the invariant not holding true, is arranged to invoke a security incident procedure. There is further described an apparatus arranged to carry out the method of protecting an item of software. There is also described a computer program which, when executed by a processor, causes the processor to carry out the method of protecting an item of software. There is additionally described a computer-readable medium storing the aforementioned computer program. Moreover, there is described an item of software comprising code at a first location, wherein the code, when executed by a processor, is arranged to check whether an invariant holds true at the first location and, in response to the invariant not holding true, is arranged to invoke a security incident procedure.

### FIELD OF THE INVENTION

The present invention relates to methods for protecting an item of software, and apparatus and computer programs for carrying out such methods.

### BACKGROUND OF THE INVENTION

It is well-known that attacks are often launched against items of software. The attacker may wish to obtain secret information contained within the item of software (such as a cryptographic key), with the aim of misusing that secret information (for example by distributing the cryptographic key to other people/systems so that those people/systems can use the cryptographic key in an unauthorised manner). Similarly, the attacker may wish to modify the execution flow of an item of software. For example, the item of software may have a decision point that checks whether a user of the item of software has certain permissions or access rights—if the user has those permissions or access rights then the item of software may grant the user access to certain functionality or data, otherwise such access is denied. The attacker may wish to try to modify the execution of the item of software at this decision point so that, even if the user does not have the permissions or access rights, the item of software still grants the user access to that certain functionality or data.

There are numerous well-known software protection techniques that can be applied to an initial item of software in order to generate a protected item of software, with the aim of making it impossible (or at least sufficiently difficult) for an attacker to be successful in his attacks.

The present invention seeks to provide an alternative method for protecting an item of software which provides various advantages over those of the prior art.

### SUMMARY OF THE INVENTION

According to a first aspect of the present invention, there is provided a method of protecting an item of software. The method comprises: (a) identifying an invariant which holds true at a specified point in the item of software; and (b) generating a protected item of software by inserting code at the specified point in the item of software. The code, when executed by a processor, is arranged to check whether the invariant holds true and, in response to the invariant not holding true, is arranged to invoke a security incident procedure.

According to a second aspect of the present invention, there is provided an apparatus arranged to carry out the method of the first aspect.

According to a third aspect of the present invention, there is provided a computer program which, when executed by a processor, causes the processor to carry out the method of the first aspect.

According to a fourth aspect of the present invention, there is provided a computer-readable medium storing the computer program of the third aspect.

According to a fourth aspect of the present invention, there is provided an item of software comprising code at a first location, wherein the code, when executed by a processor, is arranged to check whether an invariant holds true at the first location and, in response to the invariant not holding true, is arranged to invoke a security incident procedure.

Other preferred features of the present invention are set out in the appended claims.

### BRIEF DESCRIPTION OF THE DRAWINGS

Embodiments of the present invention will now be described by way of example with reference to the accompanying drawings in which:

FIG. 1 schematically illustrates an example of a computer system.

FIG. 2 schematically illustrates a system according to an embodiment of the invention.

FIG. 3 schematically illustrates a method of protecting an item of software according to an embodiment of the invention.

FIG. 4 schematically illustrates execution of a protected item of software that has been protected using the method of FIG. 3.

### DETAILED DESCRIPTION OF A PREFERRED EMBODIMENT

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1—SYSTEM OVERVIEW

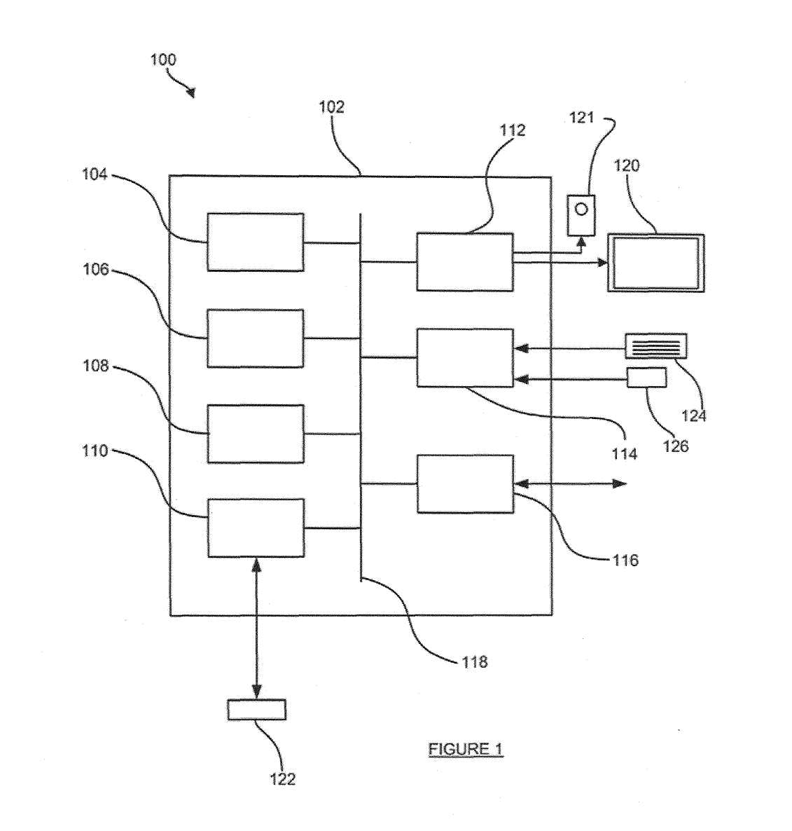

FIG. 1 schematically illustrates an example of a computer system 100. The system 100 comprises a computer 102. The computer 102 comprises: a storage medium 104, a memory 106, a processor 108, an interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code).

The memory 106 may be any random access memory (storage unit or volatile storage medium) suitable for storing data and/or computer programs (or software or instructions or code).

The processor 108 may be any data processing unit suitable for executing one or more computer programs (such as those stored on the storage medium 104 and/or in the memory 106), some of which may be computer programs according to embodiments of the invention or computer programs that, when executed by the processor 108, cause the processor 108 to carry out a method according to an embodiment of the invention and configure the system 100 to be a system according to an embodiment of the invention. The processor 108 may comprise a single data processing unit or multiple data processing units operating in parallel or in cooperation with each other. The processor 108, in carrying out data processing operations for embodiments of the invention, may store data to and/or read data from the storage medium 104 and/or the memory 106.

The interface 110 may be any unit for providing an interface to a device 122 external to, or removable from, the computer 102. The device 122 may be a data storage device, for example, one or more of an optical disc, a magnetic disc, a solid-state-storage device, etc. The device 122 may have processing capabilities—for example, the device may be a smart card. The interface 110 may therefore access data from, or provide data to, or interface with, the device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices (such as a touch screen). The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual and/or audio output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112. Additionally or alternatively, the processor 108 may be arranged to instruct the user output interface 112 to form an audio signal representing a desired audio output, and to provide this signal to one or more speakers 121 of the system 100 that is connected to the user output interface 112.

Finally, the network interface 116 provides functionality for the computer 102 to download data from and/or upload data to one or more data communication networks (not shown).

It will be appreciated that the architecture of the system 100 illustrated in FIG. 1 and described above is merely exemplary and that other computer systems 100 with different architectures (for example with fewer components than shown in FIG. 1 or with additional and/or alternative components than shown in FIG. 1) may be used in embodiments of the invention. As examples, the computer system 100 could comprise one or more of: a personal computer; a server computer; a mobile telephone; a tablet; a laptop; a television set; a set top box; a games console; other mobile devices or consumer electronics devices; etc.

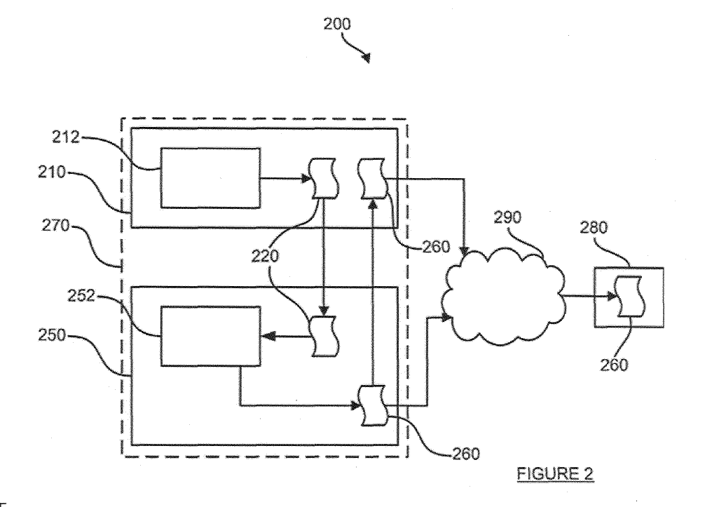

FIG. 2 schematically illustrates a system 200 according to an embodiment of the invention. The system 200 comprises: a software generation system 210; a software protection system 250; a user system 280; and a network 290.

The software generation system 210 comprises (or executes or uses) a software generation tool 212 that generates an initial item of software 220. The software generation tool 212 may be, for example, a software application that a processor of the software generation system 210 executes. The software generation system 210 may be arranged to generate the initial item of software 220 autonomously; additionally or alternatively, the software generation system 210 may be arranged to generate the initial item of software 220 under the control of one or more software developers who write, at least in part, software code that forms part of the initial item of software 220. Tools for generating or developing an item of software are very well-known and shall, therefore, not be described in more detail herein.

The initial item of software 220 may comprise one or more of source code, object code, executable code and binary code. The initial item of software 220 may be programmed or written in one or more programming languages, which may comprise compiled programming languages and/or interpreted or scripted programming languages. The initial item of software 220 may comprise one or more modules or software components or computer programs, which may be presented or stored within one or more files. Indeed, the initial item of software 220 may be an entire software application, a software library, or the whole or a part of one or more software functions or procedures, or anywhere in-between (as will be appreciated by the person skilled in the art).

The initial item of software 220, when executed by a processor, is arranged to perform (or to cause the processor to perform) data processing based on one or more items of data. Each item of data could, respectively, be any type of data, such as audio data, video data, multimedia data, text data, financial data, one or more cryptographic keys, digital rights management data, conditional access data, etc. The data processing may comprise one or more of: (a) a decision based, at least in part, on at least one of the one or more items of data; (b) a security-related function; (c) an access-control function; (d) a cryptographic function; and (e) a rights-management function. However, it will be appreciated that the data processing may comprise one or more other types of functions or operations in addition to, or as an alternative to, the above examples. As one example, the data processing may relate to providing a user access to content (such as audio and/or video data) that is received and/or stored as encrypted content, where the user is provided access to the content only if the user has appropriate access permissions/rights. The one or more items of data may, therefore, comprise: the encrypted content; details about, or an identification of, the user and/or the user system 280; data specifying one or more permissions and/or rights; and one or more cryptographic keys (which could be stored as part of the initial item of software 220). Consequently, it is desirable to protect the initial item of software 220, so that an attacker cannot use the initial item of software 220 in an unauthorised manner to thereby gain access to the content even if the attacker is not authorised to access the content, i.e. to prevent the attacker bypassing the conditional access and/or digital rights management functionality provided by the initial item of software 220 (for example, by determining one or more decryption keys, or circumventing a decision point or branch point in the initial item of software 220 that relates to whether or not a user should be provided access to the content). It will be appreciated that there is, of course, other functionality that the initial item of software 220 could perform and/or other information that the initial item of software 220 uses for which it would (for similar or perhaps alternative reasons) be desirable to protect against an attacker. Consequently, as shown in FIG. 2, the initial item of software 220 is provided (or transferred or communicated) to the software protection system 250.

The software protection system 250 comprises (or executes or uses) a software protection tool 252. The software protection tool 252 may be, for example, a software application that a processor of the software protection system 250 executes. The software protection tool 252 is arranged to receive, as an input, the initial item of software 220. The software protection tool 252 generates a protected item of software 260 based on the received initial item of software 220. Methods by which the software protection tool 252 generates the protected item of software 260 shall be described later.

The software generation system 210 and the software protection system 250 may be run or operated by different entities. Thus, as shown in FIG. 2, the software protection system 250 may output the protected item of software 260 to the software generation system 210. With this model, the software protection system 250 provides a protection service to the software generation system 210. Alternatively, the software generation system 210 and the software protection system 250 may be run or operated by the same entity—indeed, the software generation system 210 and the software protection system 250 may form part of a single system (illustrated in FIG. 2 by the dashed line 270) that uses the software generation tool 212 to generate an initial item of software 220 and that uses the software protection tool 252 to protect that initial item of software 220 by generating a protected item of software 260.

Thus, the software generation system 210 and/or the software protection system 250 may output (or provide or communicate) the protected item of software 260 to the user system 280 via the network 290. It will be appreciated, however, that distribution of the protected item of software 260 may be performed by a different entity not shown in FIG. 2.

It will also be appreciated that the protected item of software 260 may undergo various additional processing after the protected item of software 260 has been generated by the software protection system 250 and before distribution to the user system 280. It will, therefore, be appreciated that in the follow description, references to distribution or use of the protected item of software 260 include distribution or use of the piece of software that results from applying the additional processing to the protected item of software 260. For example, the protected item of software 260 may need to be compiled and/or linked with other items of software (for instance if the protected item of software 260 is to form part of a larger software application that is to be distributed to the user system 280). However, it will be appreciated that such additional processing may not be required (for example if the protected item of software 260 is a final piece of JavaScript ready for distribution).

The network 290 may be any kind of data communication network suitable for communicating or transferring the protected item of software 260 to the user system 280. Thus, the network 290 may comprise one or more of: a local area network, a wide area network, a metropolitan area network, the Internet, a wireless communication network, a wired or cable communication network, a satellite communications network, a telephone network, etc. The software generation system 210 and/or the software protection system 250 may be arranged to communicate with the user system 280 via the network 290 via any suitable data communication protocol. Indeed, the protected item of software 260 may be provided to the user system 280 via a physical medium (such as being stored on one or more CDs or DVDs), so that the network 290 may then comprise a delivery system for physically delivering the physical medium to the user system 280.

The user system 280 is arranged to use the protected item of software 260, for example by executing the protected item of software 280 on one or more processors of the user system 280.

The user system 280 may be any system suitable for executing the protected item of software 280. Thus, the user system 280 may be one or more of: a personal computer, a laptop, a notepad, a tablet computer, a mobile telephone, a set top box, a television, a server, a games console, etc. The software protection system 250 and the software generation system 210 may, for example, comprise one or more personal computers and/or server computers. Thus, each of the user system 280, the software protection system 250 and the software generation system 210 may comprise one or more respective systems 100 as described above with reference to FIG. 1.

It will be appreciated that, whilst FIG. 2 illustrates the system 200 as comprising a single user device 280, a single software generation system 210, and a single software protection system 250, the system 200 may comprise multiple user devices 280 and/or multiple software generation systems 210 and/or multiple software protection systems 250.

### 2—SOFTWARE PROTECTION TECHNIQUES

As mentioned above, the aim of the software protection tool 252 is to protect the functionality or data processing of the initial item of software 220 and/or to protect data used or processed by the initial item of software 220. In particular, the protected item of software 260 will provide the same functionality or data processing as the initial item of software 220—however, this functionality or data processing is implemented in the protected item of software 260 in a manner such that an operator of the user system 280 cannot access or use this functionality or data processing from the protected item of software 260 in an unintended or unauthorised manner (whereas if the user system 280 were provided with the initial item of software 220, then the operator of the user system 280 might have been able to access or use the functionality or data processing in an unintended or unauthorised manner).

A “white-box” environment is an execution environment for an item of software in which an attacker of the item of software is assumed to have full access to, and visibility of, the data being operated on (including intermediate values), memory contents and execution/process flow of the item of software. Moreover, in the white-box environment, the attacker is assumed to be able to modify the data being operated on, the memory contents and the execution/process flow of the item of software, for example by using a debugger—in this way, the attacker can experiment on, and try to manipulate the operation of, the item of software, with the aim of circumventing initially intended functionality and/or identifying secret information and/or for other purposes. Indeed, one may even assume that the attacker is aware of the underlying algorithm being performed by the item of software.

Secured software programs may be designed to resist white-box attacks and use a wide range of data flow and control flow transformations to obfuscate the functions implemented by the item of software. The protection applies to both static attacks and run-time attacks. In the attack scenario, the adversary has the ability to modify both the code and the data.

There are numerous ways in which the above-mentioned software protection may be implemented within the protected item of software 260, i.e. there are numerous ways in which the above-mentioned software protection techniques may be applied to the initial item of software to obtain the protected item of software 260. In particular, to generate the protected item of software 260 from the initial item of software 220, the software protection tool 252 may modify one or more portions of code within the initial item of software 220 and/or may add or introduce one or more new portions of code into the initial item of software 220. The actual way in which these modifications are made or the actual way in which the new portions of code are written can, of course, vary—there are, after all, numerous ways of writing software to achieve the same functionality.

It is desirable to prevent the attacker from modifying the execution/control flow of the item of software, for example preventing the attacker forcing the item of software to take one execution path after a decision block instead of a legitimate execution path. Alternatively/additionally, it is desirable to know when the item of software has been tampered with by an attacker, and to take appropriate action if an attack is detected.

### 3—FORMAL VERIFICATION OF AN ITEM OF SOFTWARE

Formal verification of an item of software (such as a computer program) is a known scientific field to demonstrate that a certain formal property of an item of software holds true, such as the correctness of (an implementation of) an algorithm or a communication protocol. The verification is “formal” because it is based on mathematically sound technical methods. The demonstration of correctness (or other properties) is typically in the form of a formal proof in a sound mathematical and logical system. Formal proofs are done on an abstract mathematical model of the item of software, with respect to a certain formal specification or property. Most general formal verification systems are based on Hoare logic (also known as Floyd-Hoare logic), while other logics (such as separation logic) are used for proving memory related properties. The central feature of Hoare logic is the “Hoare triple” which describes how the execution of a piece of code in an item of software changes the state of the computation. A Hoare triple is of the form:

{P}C{Q}

where P and Q are assertions and C is a command. An assertion is a predicate (a true-false statement) placed in an item of software to indicate that the developer thinks that the predicate is always true at that place. If an assertion evaluates to false at run-time, this results in an assertion failure, which may cause execution of the item of software to abort, for example. In Hoare logic, P is named the precondition and Q is named the postcondition: when the precondition P is met, executing the command C establishes the postcondition Q. Relatedly, an invariant is a condition that can be relied upon to be true during execution of an item of software, or during some portion of it. It is a logical assertion that is held to always be true at known points or locations in the execution. In other words, an invariant is formally defined as a predicate that is proven to hold true at at least one specific point in the execution of an item of software. It will be understood that invariants may also be defined and used in other logic systems (e.g. separation logic, as mentioned above).

In “defensive programming”, assertions are intended as documentation stating that an invariant holds at a specific point in an item of software. Assertions are also used in programming languages to help in catching wrong assumptions during development. Once such assertion statements are added to code, verification based systems automatically check whether they hold true at run-time. If an assertion does not hold, an error is generated at run-time by the verification system. The macro assert( ) defined in the assert.h standard library of the C programming language implements a simple verification system for C. However, to date, assertions (or similar) have not been used for protecting an item of software.

There are a number of ways/tools to identify/detect and formulate invariants automatically but they generally fall into two camps: run-time tools and compile-time tools. “Abstract interpretation” is the theoretical basis for very sophisticated analysis tools that fall into the compile-time tooling camp. Abstract interpretation can be used to identify invariants which range from simple to more complex. Abstract interpretation is done with specific properties in mind. The kind of property is expressed by the choice of an abstract domain. Some exemplary abstract domains and the types of property that each domain is suitable for are described below.

A numerical abstract domain can be used to discover numerical properties of program variables in an item of software. For example, the sign abstract domain is used to compute the sign of one or more program variables at various point in the item of software. Thus, in one example in the sign abstract domain, the precondition P may assert that a particular program variable x is positive before a command C, and the postcondition Q may assert that the same program variable x is negative following the command C. In this example, let us assume that the command C sets the value of x (which is initially positive) to another value y, where y is negative. Thus, the Hoare triple in this example would be:

{x is ‘+’} x=y {x is ‘−’}

The interval abstract domain is more precise and is used identify invariants in terms of the interval, or range, in which a program variable x falls. Thus, in one example in the interval abstract domain, the precondition P may assert that a particular program variable x falls in the interval [2, 8] before a command C, and the postcondition Q may assert that x falls in the interval [−7, −2] following the command C. Again, let us assume that the command C sets the value of x to another value y. Thus, the Hoare triple in this example would be:

{2<x<8} x=y {−7<x<−1}

Relational abstract domains are even more precise as they take into account relationships between program variables. For example, the linear equalities abstract domain will identify invariants of the form {ax+by=m}; the polyhedra abstract domain is used to identify invariants of the form {ax+by >=m}; and the ellipsoids abstract domain is used to identify invariants of the form {a(x*x)+b(y*y)+c(x*y)<=m}. Some further examples of relational numerical abstract domains are congruence relations on integers, convex polyhedral, “octagons”, and difference-bound matrices. Further invariants may be identified by considering combinations of the above-mentioned abstract domains (and any others).

### 4—A METHOD OF PROTECTING AN ITEM OF SOFTWARE

It has been inventively realised that assertions (or similar) could be used for protecting an item of software, rather than just for formal verification of an item of software.

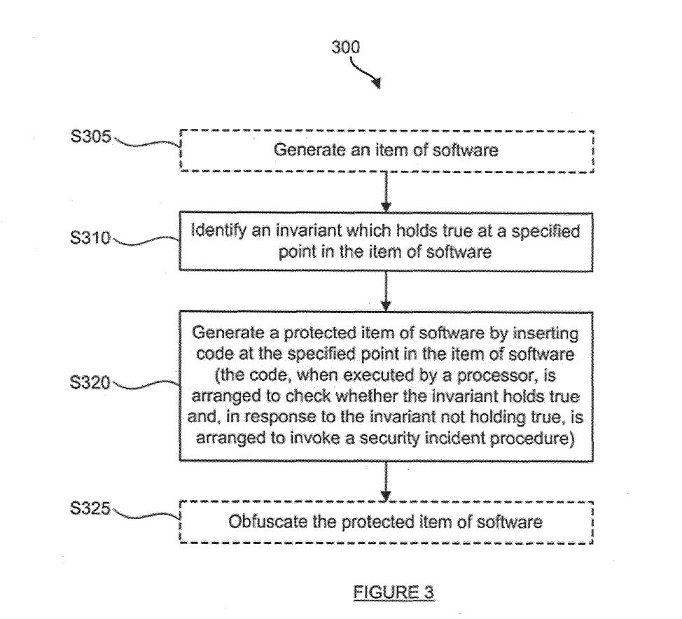

Accordingly, as illustrated schematically in FIG. 3, the present invention provides a method 300 of protecting an item of software (such as the item of software 220 described above). The method 300 comprises a step S310 of identifying an invariant which holds true at a specified point in the item of software. The method 300 further comprises a step S320 of generating a protected item of software (such as the protected item of software 260 described above) by inserting code at the specified point in the item of software. The code, when executed by a processor, is arranged to check whether the invariant holds true and, in response to the invariant not holding true, is arranged to invoke a security incident procedure.

The method 300 may include an optional initial step S305 of generating the item of software. This step may be performed by the software generation system shown in FIG. 2. The method may further include an optional step S325 of obfuscating the protected item of software and/or applying one or more further software protection techniques. Preferably, the obfuscating step S325 is performed after the invariant identification step S310 (and more preferably the obfuscating step S325 is also performed after the step S320 of generating the protected item of software) such that the invariant identification and code insertion may be performed using a more basic (i.e. cleaner) version of the item of software. This makes it easier to identify the invariant since obfuscated code is longer and more complex/intractable than the original code. However, it will be appreciated that it would also be possible to perform the obfuscation prior to steps S310 and S320 or between steps S310 and S320. In some embodiments, steps S310, S320 and S325 may be performed by the software protection tool 252, as discussed above. The processor may form part of the user system 280 shown in FIG. 2. In FIG. 3, the optional steps S305 and S325 are indicated by dashed lines.

As discussed above, an invariant is a condition that can be relied upon to be true during execution of an item of software, or during some portion of it. In the above method 300, the invariant is a condition that can be relied upon to be true at a specified point during execution of the item of software. The item of software includes one or more program variables, and the values taken by these program variables may change during the course of execution of the item of software. The condition may be defined in terms of one or more properties or values of at least one program variable in the item of software at the specified point, and/or it may be defined in terms of one or more relationships between program variables in the item of software at the specified point. In other words, the invariant identifies one or more properties and/or values of one or more program variables in the item of software (and/or relationships therebetween) that can be relied upon to be true at the specified point during execution of the item of software. Importantly, we are referring here to execution of the initial item of software, when not being attacked; in other words, the invariant should hold true at the specified point during execution under normal operating conditions. Thus, the invariant may be considered as a function of one or more program variables in the item of software, and the function may be considered as a predicate, in that it may be true or false depending on the values/properties of its variables. According to the method 300, step S310 identifies an invariant which holds true at a specified point in the (initial/unattacked) item of software.

Thus, the method 300 inserts code into the item of software to check whether the invariant does indeed hold true at the specified point at run-time. Hence, importantly, the “invariant check” is being carried out at run-time (i.e. during execution of the protected item of software) rather than at compile-time.

The method 300 effectively provides an “invariant check” generation system that uses a formal verification based system to produce potentially complex invariants that are implicit to the item of software and often obscure to an attacker. These invariant checks are added to e.g. the source code of the item of software and the added code protects against manipulation of the data and against modification of the control flow of the item of software.

It is desirable that the invariant checks are integrated/inserted into the item of software in such a way as to hide the fact that there is an invariant check that may instigate the security incident procedure. Known software obfuscation techniques may be used in this regard, and see also WO2013/142980 and U.S. Pat. No. 6,192,475, the entire disclosures of which are incorporated herein by reference. The invariant check generation system inserts the added code in a way that enables later software obfuscation tools (e.g. in step S325) to utilise the invariant check statements to easily generate obfuscated versions of the invariant checks that operate on transformed data and on transformed code.

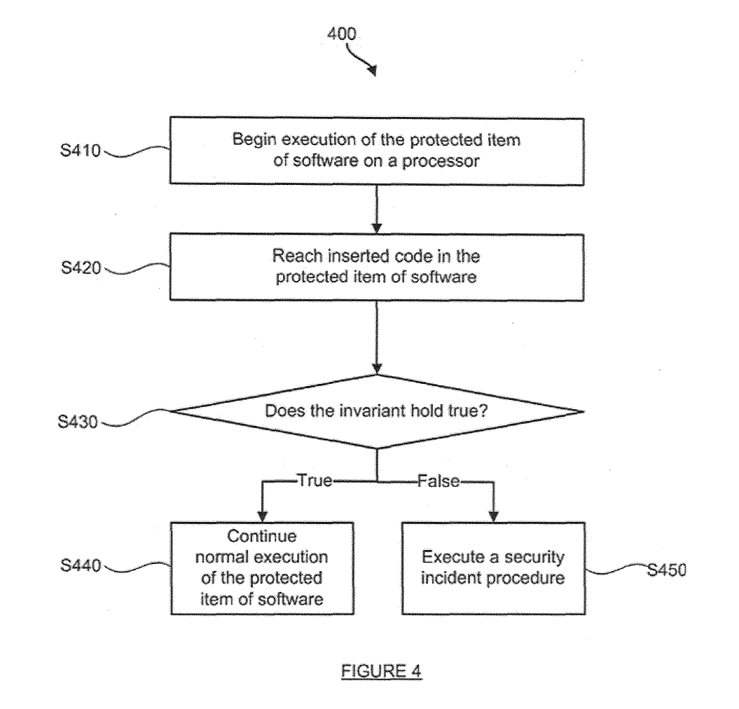

FIG. 4 schematically illustrates the run-time execution 400 of a protected item of software that has been protected according to the method 300 of FIG. 3. At step S410, execution of the protected item of software begins. The execution of the protected item of software continues until such time as the execution reaches the inserted code (as referenced in step S320 of FIG. 3 above). At step S420, the execution of the protected item of software reaches the inserted code. As previously mentioned, the inserted code is arranged to check whether the invariant holds true. Therefore, at step S430, this invariant check occurs. If the invariant is found to hold true, execution of the protected item of software continues as normal at step S440. In other words, execution of the protected item of software continues in the same way as would be expected for the initial item of software; specifically, execution of the protected item of software continues to the code immediately after the invariant check. If, on the other hand, the invariant check fails (i.e. if the invariant is found to be false), then the inserted code invokes a security incident procedure at step S450.

As discussed above, the invariant has been defined such that it holds true at a specified point in the item of software (e.g. the initial item of software 220). Thus, in the absence of an attack or any tampering with the protected item of software (e.g. the protected item of software 260), the invariant should also hold true at the specified point during execution of the protected item of software (i.e. the check at step S430 should result in a finding of “true” thereby leading to continued execution of the protected item of software at step S440). However, if there has been an attack on (or tampering with or corruption of) the protected item of software, the protected item of software, or the data being processed or used by the protected item of software, may have been modified such that the invariant no longer holds true at the specified point at run-time. Thus, whilst the invariant should (i.e. is intended to) hold true at run-time in the protected item of software, it is possible that the invariant will not hold true due to an attack on the protected item of software. In this case, execution of a protected item of software that has been protected according to the method 300 is able to indirectly identify that there has been an attack by means of the failed invariant check at run-time (see steps S430 and S450 in FIG. 4). In response to a failed invariant check at run-time, the code is arranged to invoke (or instigate or execute or carry out) a security incident procedure as shown in step S450 of FIG. 4.

The method 300 is particularly useful because an attacker is unlikely to be aware that the invariant exists in the protected item of software, particularly if the invariant is based on a relatively complex combination of the properties and/or values of the program variables. Clearly, if an attacker is not aware that the invariant exists, they will not know to modify the protected item of software in such a way that the invariant still holds at the specified point. Thus, an attack which is intended to be undetectable becomes detectable by performing the invariant check of step S430, the invariant check having been inserted into the item of software by means of the method 300.

It will be appreciated that the method 300 may not involve protecting the entire item of software. In this case, the method 300 may further comprise selecting a portion of the item of software to be protected. The portion may include one or more separate blocks of code. In this embodiment, the specified point (i.e. the point at which the invariant holds true) is located in the selected portion of the item of software. For example, it is likely that some portions of code in an item of software will be more eligible for attack (i.e. more attractive to attackers) than others. In particular, an attacker is likely to target portion(s) of code which potentially enable the attacker to obtain secret information contained within the item of software (such as a cryptographic key), or portions of code which perform verification of the secret information before performing particular operations. Thus, the method 300 may first involve selection those portions of code which relate to these highly sensitive operations.

When invoked at step S450, the security incident procedure may be arranged to cause the processor to take a predetermined action, as required. In other words, the security incident procedure may be configured as appropriate such that a desired resultant action occurs. The security incident procedure may be configured by the software protection system 250. For example, the software protection tool 252 may add code to the item of software for performing the security incident procedure. The predetermined action which occurs following a failed invariant check may differ from case to case, making the method 300 very flexible. For example, if a highly critical (very important) invariant is found not to hold at the relevant specified point at run-time, then a correspondingly serious predetermined action may be appropriate. For example, when the security incident procedure is invoked, it may be arranged to cause the processor to cease execution of the protected item of software, and/or to prevent execution of the protected item of software for a predetermined period of time following the invocation of the security incident procedure, and/or to prevent future execution of the protected item of software. Alternatively, if a less critical invariant is found not to hold at the relevant specified point at run-time, then a correspondingly less serious predetermined action may be appropriate. For example, when the security incident procedure is invoked, it may be arranged to cause the processor to ensure that data output by the protected item of software is corrupted, and/or to provide a notification regarding the invocation of the security incident procedure. The corrupted output data may render the protected item of software unusable. The notification may be provided to a provider of the item of software (e.g. the software generation system 210 of FIG. 2), and/or a provider of the protected item of software (e.g. the software protection system 250 of FIG. 2), and/or another interested entity. The notification may comprise data identifying the entity executing the protected item of software (e.g. data relating to the user system 280 of FIG. 2, or some other data relating to the processor). The notification preferably includes data identifying the invariant which has resulted in the failed check.

In some embodiments, the invariant may hold true only at the specified point in the item of software. Alternatively, the invariant may additionally hold true at additional points other than the specified point in the item of software. For example, the invariant may hold true during execution of a portion of the item of software, where the portion includes one or more particular blocks of code in the item of software. In this case, the specified point may be defined as any point in the one or more particular blocks of code. In other words, if the invariant holds true during execution of one or more particular blocks of code, the code to be inserted into the item of software at step S320 may be inserted at any point in the one or more particular blocks of code in the item of software so as to provide a protected item of software. The same code may in fact be inserted at multiple points in the one or more particular blocks of code, if desired, so as to provide multiple software protection invariant check points. In some cases, the invariant may hold true during execution of the entire item of software (i.e. throughout the execution of the item of software). In this case, the specified point may be defined as any point in the item of software. Again, the same code may be inserted at multiple points in the item of software, if desired, so as to provide multiple software protection invariant checks.

In some embodiments, inserting code at the specified point in the item of software may, at least in part, be performed automatically. For example, the insertion may be performed automatically by the software protection tool 252 of FIG. 2. Alternatively/additionally, the insertion may, at least in part, be performed manually or with human interaction.

Equally, in some embodiments, the step S310 of identifying an invariant may, at least in part, be performed automatically. For example, the identification may be performed automatically by the software protection tool 252 of FIG. 2. For example, the step of identifying an invariant may comprise using a static program analysis tool. Exemplary static program analysis tools include Astrée, CPAchecker, ÉCLAIR, Fluctuat, Polyspace, Coverity Prevent, Klocwork Insight, Parasoft Jtest, Parasoft C/C++ test, Red Lizard's Goanna, and Frama-C value analysis. Alternatively/additionally, the identification may, at least in part, be performed manually or with human interaction.

In some embodiments, the step S310 of identifying an invariant comprises identifying a plurality of invariants, each of which holds true at a respective specified point in the item of software, and then selecting an invariant from the plurality of invariants to be said invariant. Of course, it will be appreciated that more than one invariant may be selected from the plurality of invariants, and the method 300 may be applied in respect of each of the selected invariants. Further detail regarding the applicability of the method 300 to more than one invariant is given below.

In some embodiments, the invariant may be considered to be a first invariant, the specified point may be considered to be a first specified point, and the inserted code may be considered to be first code, such that the first invariant holds true at the first specified point in the item of software, and such that the first code is inserted at the first specified point in the item of software so as to generate the protected item of software. In this case, the method 300 may further comprise identifying a second invariant which holds true at a second specified point in the item of software. The second invariant may or may not be the same as the first invariant, and the second specified point may or may not be the same as the first specified point in the item of software. However, to avoid redundancy, the first and second invariants should not be the same if the first and second specified points are the same, and vice versa. The step S320 of generating a protected item of software may further comprise inserting second code at the second specified point in the item of software. The second code, when executed by the processor, is arranged to check whether the second invariant holds true and, in response to the second invariant not holding true, is arranged to invoke a second security incident procedure. The second security incident procedure may be the same as or different to the first security incident procedure.

Let us consider a specific example in which multiple invariants I₁, I₂, . . . , Iₙ are identified in the item of software (e.g. using a static program analysis tool such as Frama-C value analysis). In this case, a subset of the identified invariants may be selected for checking as part of the protected item of software: let us assume that a subset of three invariants, namely I₁, I₇, and I₂₂, are selected (of course, it will be appreciated that a different subset of invariants could equally be selected, or alternatively all of the invariants could be selected). Assume that invariant I₁ only holds true at a specified point P₁ in the item of software. Assume that invariant I₇ only holds true at a different point P₇ in the item of software. Assume that invariant I₂₂ holds true at multiple points in the item of software, namely points P₁, P₇ and P₂₂. In this example, the protected item of software could be generated by inserting code into the item of software including one or more of the following:
1. Code inserted at point P₁ in the item of software to perform an invariant check for invariant I₁
2. Code inserted at point P₇ in the item of software to perform an invariant check for invariant I₇
3. Code inserted at point P₁ in the item of software to perform an invariant check for invariant I₂₂
4. Code inserted at point P₇ in the item of software to perform an invariant check for invariant I₂₂
5. Code inserted at point P₂₂ in the item of software to perform an invariant check for invariant I₂₂

Each portion of code listed above could be inserted into the item of software sequentially so as to progressively generate the protected item of software. Alternatively, each portion of code listed above could be inserted into the item of software at the same time so as to generate the protected item of software in one go.

At least one of the portions of code listed above may comprise explicit code inserted into the item of software. For example, an IF-THEN statement could be inserted into the item of software as follows:

IF (INVARIANT = FALSE) THEN

CALL SECUTITY_INCIDENT_PROCEDURE

ENDIF

Alternatively/additionally, at least one of the portions of code listed above may comprise a respective macro similar to the assert( ) macro in the C programming language. However, the functionality invoked by the inserted portion of code is not the same as that of the assert( ) macro since the inserted portion of code is arranged to invoke the security incident procedure if appropriate. Alternatively/additionally, at least one of the portions of code listed above may call a function which performs the respective invariant check. Clearly, the macro and/or the function would also need to be available to (e.g. defined in) the item of software if used.

An apparatus arranged to carry out the method 300 is also envisaged. As mentioned above, such an apparatus may be the software protection system 250 of FIG. 2. A computer program which, when executed by a processor, causes the processor to carry out the method 300 is also envisaged. In addition, a computer-readable medium storing such a computer program is also envisaged.

### 5—EXAMPLE

An invariant check may be specified in the form of a Boolean condition that gets inserted at the specified point(s) where the invariant holds. For example:

INVARIANT_CHECK (2x+3y>=13)
where x and y are program variables, and “INVARIANT_CHECK” is the call to the macro or function which performs the invariant check and calls the security incident procedure if necessary. In this example, the invariant is 2x+3y>=13. The exemplary invariant check given above makes use of the polyhedra abstract domain mentioned in section 3 above. The invariant check can be inserted separately and post-development, perhaps by a security assurance person who may be different from the software developer who created the initial item of software 220, and after the formal verification tooling has run on the item of software and produced the invariants.

Consider the following function “main” in C-type programming language:

```
static char string[11]=”A nice cat”;
static char key[11]=”ABCDEFGHIJ”;
int main(void)
{
  for(int x=0; x<10; x++)
  {
```

| | |
|---|---|
| string[x]=string[x]\hat{ }key[x]; | <======= Line 8 |

```
  }
  return 0;
}
```

According to the method 300, it is necessary to identify an invariant in step S310. As discussed above, this may be done using a static program analysis tool such as Frama-C value analysis. Below is a part of the result of value analysis done by the Frama-C tool on the function “main” listed above prior to the statement in line 8 of the “main” function:

Function: main
Statement: 8 (line 8 in xor.c)
Variable string has type “char [11]”.
It is a global variable.
It is referenced and its address is not taken.
Before statement:
string [0]ε{0; 65}
[1]ε{32; 98}
[2]ε{45; 110}
[3]ε{45; 105}
[4]ε{38; 99}
[5]ε{35; 101}
[6]ε{32; 103}
[7]ε{43; 99}
[8]ε{40; 97}
[9]ε{62; 116}
[10]ε{0}
   Similarly, after the statement in line 8 of the “main” function, the Frama-C tool provides the following value analysis:
   string [0]ε{0}
[1]ε{32; 98}
[2]ε{45; 110}
[3]ε{45; 105}
[4]ε{38; 99}
[5]ε{35; 101}
[6]ε{32; 103}
[7]ε{43; 99}
[8]ε{40; 97}
[9]ε{62; 116}
[10]ε{0}

As an example, string [2] may be used to formulate an invariant either before or after execution of the statement in line 8. Thus, below we show an example of a protected item of software produced by performing the method 300 on the original “main” function shown above:

```
static char string[11]=”A nice cat”;
static char key[11]=”ABCDEFGHIJ”;
int main(void)
{
  for(int x=0; x<10; x++)
  {
```

| | |
|---|---|
| string[x]=string[x]\hat{ }key[x]; | <======= Line 8 |

```
  INVARIANT_CHECK (x==2 && string[x] >= 45 && string[x] <=
  110)
```

```
  }
  return 0;
}
```

The newly added statement above is the inserted code referenced in step S320 of FIG. 3. At run-time, the newly added statement calls the macro or function which performs the invariant check and calls the security incident procedure if the condition on string [2] is not met.

It will be understood that code above is exemplary and the method 300 of the invention is not specific to C/C++ programming languages. In fact, the method 300 is not even specific to traditional imperative languages. Invariants exist in programs written in any language such as declarative languages (e.g. DRM policy languages). If an analysis tools does not (yet) exist for a particular programming language, then it is possible to calculate the invariants on a case-by-case basis (at least partly manually) in step S310 of the method 300.

### 6—MODIFICATIONS

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps as described above may each be implemented by corresponding respective modules; multiple method steps may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method, implemented by one or more processors, of protecting an item of software, the method comprising:
identifying an invariant which holds true at a specified point in the item of software; and
generating a protected item of software by inserting code at the specified point in the item of software, wherein the code, when executed by a processor, is arranged to check whether the invariant holds true and, in response to the invariant not holding true, is arranged to invoke a security incident procedure.

2. The method of claim 1 wherein the security incident procedure, when invoked, is arranged to cause the processor to do one or more of the following:
(a) cease execution of the protected item of software;
(b) prevent execution of the protected item of software for a predetermined period of time following the invocation of the security incident procedure;
(c) prevent future execution of the protected item of software;
(d) ensure that data output by the protected item of software is corrupted;
(e) provide a notification regarding the invocation of the security incident procedure to at least one of a provider of the item of software, a provider of the protected item of software, and another entity.

3. The method of claim 2 wherein the notification comprises data identifying an entity executing the protected item of software.

4. The method of claim 1 wherein said inserting code at the specified point in the item of software is, at least in part, performed automatically.

5. The method of claim 1 wherein the step of identifying an invariant is, at least in part, performed automatically.

6. The method of claim 5 wherein the step of identifying an invariant comprises using a static program analysis tool.

7. The method of claim 1 wherein the step of identifying an invariant comprises:
identifying a plurality of invariants, each of which holds true at a respective specified point in the item of software; and
selecting an invariant from the plurality of invariants to be said invariant.

8. The method of claim 1 wherein the method further comprises identifying a second invariant which holds true at a second specified point in the item of software, and wherein the step of generating a protected item of software further comprises inserting second code at the second specified point in the item of software, wherein the second code, when executed by the processor, is arranged to check whether the second invariant holds true and, in response to the second invariant not holding true, is arranged to invoke a second security incident procedure.

9. The method of claim 1 wherein the method further comprises selecting a portion of the item of software to be protected, and wherein the step of identifying an invariant comprises identifying an invariant which holds true at a specified point in said portion of the item of software.

10. The method of claim 1 wherein the method further comprises obfuscating the protected item of software.

11. An apparatus comprising one or more processors arranged to protect an item of software by:
identifying an invariant which holds true at a specified point in the item of software; and
generating a protected item of software by inserting code at the specified point in the item of software, wherein the code, when executed by a processor, is arranged to check whether the invariant holds true and, in response to the invariant not holding true, is arranged to invoke a security incident procedure.

12. A One or more tangible computer readable media comprising computer code program which, when executed by a processor, causes the processor to protect an item of software by:
identifying an invariant which holds true at a specified point in the item of software; and
generating a protected item of software by inserting code at the specified point in the item of software, wherein the code, when executed by a processor, is arranged to check whether the invariant holds true and, in response to the invariant not holding true, is arranged to invoke a security incident procedure.

13. (canceled)

14. An item of software comprising computer program code at a first location, wherein the computer program code, when executed by a processor, is arranged to check whether an invariant holds true at the first location and, in response to the invariant not holding true, is arranged to invoke a security incident procedure.
